(19) United States
(12) Patent Application Publication
(10) Pub. No.: US 2006/0058492 A1
(43) Pub. Date: Mar. 16, 2006

(54) Polyisocyanate prepolymer component for preparing a polyurethane-polyurea polymer

(75) Inventor: Michael S. Cork, Richardson, TX (US)

Correspondence Address: SCOTT T. GRIGGS, 1717 MAIN STREET, SUITE 3400, DALLAS, TX, 75201, US

(73) Assignee: Specialty Products, Inc.

(21) Appl. No.: 10/980,456

(22) Filed: Nov. 3, 2004

Related U.S. Application Data
(60) Provisional application No. 60/611,124, filed on Sep. 15, 2004.

(51) Int. Cl. C08G 18/00

(52) U.S. Cl. 528/44

(57) ABSTRACT

A polyisocyanate prepolymer component is disclosed that reacts with an isocyanate-reactive component in the preparation of a polyurethane-polyurea polymer. In one embodiment, a polyisocyanate in an amount of from about 50% to about 98% is reacted with a reactive component in an amount from about 2% to about 50% by weight. The polyisocyanate has an average functionality of about 2 to about 3. The reactive component includes from about 20% to about 100% by weight, based on 100% by weight of the reactive component, of at least one organic compound having a mercaptan functional moiety. The resulting polyisocyanate prepolymer component has an NCO group content of about 3% to about 50%.

### PRIORITY STATEMENT & CROSS-REFERENCE TO RELATED APPLICATIONS

This application claims priority from co-pending U.S. Patent Application No. 60/611,124, entitled “Polyurethane-polyurea Polymer” and filed on Sep. 15, 2004, in the name of Michael S. Cork. This application discloses subject matter related to the subject matter disclosed in the following commonly owned, co-pending patent applications: (1) “Isocyanate-reactive Component for Preparing a Polyurethane-polyurea Polymer,” filed on Nov. 3, 2004, application Ser. No. ______ (Attorney Docket No. 1006.1002), in the name of Michael S. Cork; and (2) “System and Method for Coating a Substrate,” filed on Nov. 3, 2004, application Ser. No. ______ (Attorney Docket No. 1006.1003), in the name of Michael S. Cork; both of which are hereby incorporated by reference for all purposes.

### TECHNICAL FIELD OF THE INVENTION

This invention relates, in general, to polyurethane-polyurea polymers and, in particular, to a polyisocyanate prepolymer component that reacts with an isocyanate-reactive component to synthesize a polyurethane-polyurea polymer.

### BACKGROUND OF THE INVENTION

Polyurethanes and related polyureas are used in a wide variety of applications, including fibers (particularly the elastic type), adhesives, coatings, elastomers, and flexible and rigid foams. A number of methods have been employed to prepare polyurethanes and polyureas. For example, in industrial applications, polyurethane-polyurea polymers are typically synthesized by the condensation reaction of a polyisocyanate, such as diphenylmethane diisocyanate, and a resin that includes a hydroxyl-containing material. Resins may also include linear polyesters, polyethers containing hydroxyl groups, amine-substituted aromatics, and aliphatic amines. The resulting polyurethane-polyurea polymer provides resistance to abrasion, weathering, and organic solvents and may be utilized in a variety of industrial applications as a sealant, caulking agent, or lining, for example.

It has been found, however, that the existing polyurethane-polyurea polymers are not necessarily successful in aggressive environments. The existing polyurethane-polyurea polymers exhibit insufficient chemical and/or permeability resistance when placed into prolonged contact with organic reagents such as fuels and organic solvents. Accordingly, further improvements are warranted in the preparation of polyurethane-polyurea polymers.

### SUMMARY OF THE INVENTION

A polyisocyanate prepolymer component is disclosed that reacts with an isocyanate-reactive component in the preparation of a polyurethane-polyurea polymer. The polyisocyanate prepolymer component includes mercaptan functional moieties and the resulting polyurethane-polyurea polymer performs well in all environments. In particular, the polyurethane-polyurea polymer prepared according to the teachings presented herein exhibits improved chemical resistance and/or impermeability in the presence of organic reagents.

In one embodiment, a polyisocyanate in an amount of from about 50% to about 98% is reacted with a reactive component in an amount from about 2% to about 50% by weight. The polyisocyanate has an average functionality of about 2 to about 3. The reactive component includes from about 20% to about 100% by weight, based on 100% by weight of the reactive component, of at least one organic compound having a mercaptan functional moiety. The resulting polyisocyanate prepolymer component has an NCO group content of about 3% to about 50%.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

The polyurethane-polyurea polymer may be formulated as an A-side, which may be referred to as a polyisocyanate prepolymer or polyisocyanate prepol component, and a B-side, which may be referred to as a resin or isocyanate-reactive component. In one embodiment, the polyurethane-polyurea polymer is synthesized using a high-pressure impingement mixing technique wherein a metered amount of the polyisocyanate prepolymer component and a metered amount of the isocyanate-reactive component are sprayed or impinged into each other in the mix head of a high-pressure impingement mixing machine using pressures between 2,000 psi and 3,000 psi and temperatures in the range of about 145° F. to about 190° F. (about 63° C. to about 88° C.). The mixed formulation immediately exits the mix head into a mold to form a cast polyurethane-polyurea elastomer or as a spray to form a polyurethane-polyurea polymer coating on a substrate. It should be appreciated that the polyisocyanate component and the isocyanate-reactive component may be mixed in ratios other than 1:1. For example, the mixing ratios between the polyisocyanate component and the isocyanate-reactive component may range from 1:10 to 10:1. Additionally, various types of plural component spray equipment may be employed in the preparation of the polyurethane-polyurea polymer. Further details concerning the applications of the polyurethane-polyurea polymer may be found in the following commonly owned, co-pending application: “System and Method for Coating a Substrate,” filed on Nov. 3, 2004, application Ser. No. ______ (Attorney Docket No. 1006.1003), in the name of Michael S. Cork; which is hereby incorporated by reference for all purposes. The overall synthesis of the polyurethane-polyurea polymer is very fast and the pot lives of successful formulations and tack free time are short compared to coating formulations that are applied as powders and then heated to melt the powders into coatings.

The polyisocyanate prepolymer component has an NCO group content of about 3% to about 50% and an average functionality of about 2 to about 3. Preferably, the polyisocyanate prepolymer component has an NCO group content of about 13% to about 24%. The polyisocyanate prepolymer comprises the reaction product of a polyisocyanate with a reactive component. In one embodiment, the polyisocyanate and the reactive component are agitated in the presence of an amine catalyst or organometallic catalyst.

Suitable polyisocyanates, which are compounds with two or more isocyanate groups in the molecule, include polyisocyanates having aliphatic, cycloaliphatic, or aromatic molecular backbones. Examples of suitable aliphatic polyisocyanates include aralkyl diisocyanates, such as the tetramethylxylyl diisocyanates, and polymethylene isocyanates, such as 1,4-tetramethylene diisocyanate, 1,5-pentamethylene diisocyanate, hexamethylene diisocyanates (HDIs or HMDIs), 1,6-HDI, 1,7-heptamethylene diisocyanate, 2,2,4-and 2,4,4-trimethylhexamethylene diisocyanate, 1,10-decamethylene diisocyanate and 2-methyl-1,5-pentamethylene diisocyanate. Additional suitable aliphatic polyisocyanates include 3-isocyanatomethyl-3,5,5-trimethylcyclohexl isocyanate, bis(4-isocyanatocyclohexyl)methane, 3,3,5-trimethyl-5-isocyanato-methyl-cyclohexyl isocyanate, which is isophorone diisocyanate (IPDI), 1,4-cyclohexane diisocyanate, m-tetramethylxylene diisocyanate, 4,4′-dicyclohexlmethane diisocyanate, and hydrogenated materials such as cyclohexylene diisocyanate and 4,4′-methylenedicyclohexyl diisocyanate (Hl2MDI). Suitable aliphatic isocyanates also include ethylene diisocyanate and 1,12-dodecane diisocyanate.

Cycloaliphatic isocyanates that are suitable include cyclohexane-1,4-diisocyanate, cyclobutane-1,3-diisocyanate, cyclohexane-1,3-diisocyanate, 1-isocyanato-2-isocyanatomethyl cyclopentane, 1-isocyanato-3, 3, 5-trimethyl-5-isocyanatomethyl cyclohexane, 2,4′-dicyclohexylmethane diisocyanate, and 4,4′-dicyclohexylmethane diisocyanate.

Aromatic polyisocyanates that are suitable include phenylene diisocyanate, toluene diisocyanate (TDI), xylene diisocyanate, 1,5-naphthalene diisocyanate, chlorophenylene 2,4-diisocyanate, bitoluene diisocyanate, dianisidine diisocyanate, tolidine diisocyanate, and alkylated benzene diisocyanates generally. Methylene-interrupted aromatic diisocyanates such as diphenylmethane diisocyanate (MDI), especially the 4,4′-isomer including alkylated analogs such as 3,3′-dimethyl-4,4′-diphenylmethane diisocyanate and polymeric methylenediphenyl diisocyanate are also suitable. Suitable aromatic diisocyanates which may also be used include 3,3′-dimethoxy-4,4′-bisphenylenediisocyanate, 3,3′-diphenyl-4,4′-biphenylenediisocyanate, 4,4′-biphenylene diisocyanate, 4-chloro-1,3-phenylene diisocyanate, 3,3′-dichloro-4,4′-biphenylene diisocyanate, and 1,5-naphthalene diisocyanate.

It should be appreciated that the use of various oligomeric polyisocyanates (e.g., dimers, trimers, polymeric) and modified polyisocyanates (e.g., carbodiimides, uretone-imines) is also within the scope of the present teachings. Moreover, homopolymers and prepolymers incorporating one or more of these aliphatic, cyclic, and aromatic compounds or mixtures or reaction products thereof are suitable. Preferably, the polyisocyanate component includes MDI.

The selection of polyisocyanate or polyisocyanates influences the flexibility of the polyurethane-polyurea polymer. By way of example, flexibility can be increased with minimum impact to chemical resistance by selecting a polyisocyanate that includes a blend of TDI, caprolactone, and MDI wherein the greater the amounts of TDI and caprolactone, the greater the flexibility. By way of another example, Desmodur® W aliphatic diisocyanate from Bayer Corporation (Pittsburgh, Pa.) may be utilized to increase the flexibility of the polyurethane-polyurea polymer.

The reactive component includes from about 20% to about 100% by weight, based on 100% by weight of the reactive component, of at least one organic compound having a mercaptan functional moiety. Additionally, the reactive component may include polyols, glycols, amine-substituted aromatics, and aliphatic amines, for example. As those skilled in the art will appreciate, an excess of polyisocayante is reacted with the reactive component such that the polyisocyanate prepolymer includes reactive NCO groups for the reaction with the isocyanate-reactive component.

The use of a polyisocyanate prepolymer component including mercaptan functional moieties in the synthesis of a polyurethane-polyurea polymer results in a polymer having excellent tensile properties and tear strength properties, substantially no volatile organic compounds (VOCs), abrasion and weathering resistance, and electrical resistance. Additionally, the incorporation of the sulfur into the synthesized polyurethane-polyurea polymer imparts improved chemical resistance and/or reduced permeability. In one implementation, the polyurethane-polyurea polymer has a mercaptan content of about 0.5% to about 5.0%. In another implementation, the polyurethane-polyurea polymer has a mercaptan content of about 1.2% to about 2.4%.

The organic compound having a mercaptan functional moiety is preferably a polysulfide. Most preferably, the polysulfide is a thiol having the following general formula:
R—SH
wherein R equals an aliphatic, cyclic, or aromatic organic compound having any arrangement of functional groups. Typically, the polysulfide will include two or more sulfur atoms and contain reactive mercaptan end-groups according to the following general formula:
HS—R′(SS—R″)ₙ—SH
wherein R′ and R″ are each an aliphatic, cyclic, or aromatic organic compound having any arrangement of functional groups.

Suitable polysulfides include aliphatic polysulfides (ALIPS) and polymercaptans. The formation of ALIPS occurs by way of an equilibrating polycondensation reaction from bifunctional organic compounds such as dihalogen alkanes or dihalogen ether and alkali metal polysulfide solution. Suitable ALIPS include THIOPLAST™ polysulfides manufactured by Akzo Nobel Inc. (Chicago, Ill.) and THIOKOL® polysulfides manufactured by Toray Industries, Inc. (Tokyo, Japan).

THIOPLAST™ polysulfides, which are the most preferable polysulfides, result from the polycondensation of bis-(2-chloroethyl-)formal with alkali polysulfide. This reaction generates long-chain macromolecules which are cut to the required chain length by reductive splitting with sodium dithionite. The disulfide groups are at the same converted into reactive thiol terminal groups. By introducing a trifunctional component (e.g., 1,2,3-trichloropropane) during synthesis a third thiol terminal group can be added to a specific number of molecules to determine the extent of cross-linking during the curing process. The following tables, Tables I-III, provide a survey of the chemical properties of suitable THIOPLAST™ polysulfides.

TABLE I
Chemical Survey of THIOPLAST ™ G10,
G112, and G131 Polysulfides

| THIOPLAST ™ Type | G10 | G112 | G131 |
|---|---|---|---|
| Molecular Weight (g/mol) | 4,400-4,700 | 3,900-4,300 | 5,000-6,500 |
| Mercaptan Content (%) | 1.4-1.5 | 1.5-1.7 | 1.0-1.3 |

TABLE II
Chemical Survey of THIOPLAST ™ G1, G12, and G21 Polysulfides

| THIOPLAST ™ Type | G1 | G12 | G21 |
|---|---|---|---|
| Molecular Weight (g/mol) | 3,300-3,700 | 3,900-4,400 | 2,100-2,600 |
| Mercaptan Content (%) | 1.8-2.0 | 1.5-1.7 | 2.5-3.1 |

TABLE III
Chemical Survey of THIOPLAST ™ G22, G44, and G4 Polysulfides

| THIOPLAST ™ Type | G22 | G44 | G4 |
|---|---|---|---|
| Molecular Weight (g/mol) | 2,400-3,100 | <1,100 | <1,100 |
| Mercaptan Content (%) | 2.1-2.7 | >5.9 | >5.9 |

As previously mentioned, THIOKOL® polysulfides are also suitable ALIPS. The following tables, Tables IV-VI, provide a survey of the chemical properties of suitable THIOKOL® polysulfides.

TABLE IV
Chemical Survey of THIOKOL ® LP-33,
LP-3, and LP-541 Polysulfides

| THIOKOL ® Type | LP-33 | LP-3 | LP-541 |
|---|---|---|---|
| Molecular Weight (g/mol) | 1,000 | 1,000 | 4,000 |
| Mercaptan Content (%) | 5.0-6.5 | 5.9-7.7 | 1.5-1.7 |

TABLE V
Chemical Survey of THIOKOL ® LP-12 C,
LP-32 C, and LP-2 C Polysulfides

| THIOKOL ® Type | LP-12 C | LP-32 C | LP-2 C |
|---|---|---|---|
| Molecular Weight (g/mol) | 4,000 | 4,000 | 4,000 |
| Mercaptan Content (%) | 1.5-1.7 | 1.5-2.0 | 1.7-2.2 |

TABLE VI
Chemical Survey of THIOKOL ® LP-31,
LP-977 C, and LP-980 C Polysulfides

| THIOKOL ® Type | LP-31 | LP-977 C | LP-980 C |
|---|---|---|---|
| Molecular Weight (g/mol) | 8,000 | 2,500 | 2,500 |
| Mercaptan Content (%) | 1.0-1.5 | 2.8-3.5 | 2.5-3.5 |

As previously discussed, polymercaptans are also suitable polysulfides. Polymercaptans are formed from aliphatic, cyclo-aliphatic, or aromatic molecular segments, which can also contain individual sulfur atoms, e.g., in the form of thioether or similar compounds, but which have no disulfide bridges and which have reactive mercaptan groups according to the general formula:
HS—Rₙ—SH
where R equals acrylate, butadiene, butadiene acrylonitrile, or other suitable compound. In addition to the mercaptan end-groups, the polymercaptans may include hydroxyl end-groups, olefin end-groups, alkoxysilyl end-groups, or alkyl end-groups, for example. The following listing provides examples of suitable polymercaptans.

BAYTHIOL® is a mercaptan-terminated polyurethane from Bayer AG (Leverkusen, Germany).

HYCAR® MTA is a mercaptan-terminated acrylate-polymerisate from B.F. Goodrich Chemical Corporation (Cleveland, Ohio).

HYCAR® MTB is a mercaptan-terminated butadiene-polymerisate from B.F. Goodrich Chemical Corporation (Cleveland, Ohio).

HYCAR® MTBN (1300x10) is a mercaptan-terminated butadiene-acrylnitrile-co-polymerisate from B.F. Goodrich Chemical Corporation (Cleveland, Ohio).

PERMAPOL® P-2 is a mercaptan-terminated liquid polymer from Product Research Corporation (Glendale, Calif.).

PERMAPOL® P-3 is a mercaptan-terminated liquid polymer from Product Research Corporation (Glendale, Calif.).

PERMAPOL® P-5 is a chemically-modified ALIPS from Product Research Corporation (Glendale, Calif.).

PM® polymer is a mercaptan-terminated liquid polymer from Philips Chemical Corporation (Bartlesville, Okla.).

As previously alluded to, the reactive component may include from about 0% to about 80%, based upon 100% by weight of the reactive component, of other organic compounds such as polyols, glycols, amine-substituted aromatics, and aliphatic amines, for example. Suitable polyols for use in the reactive component consist essentially of polyether or polyester polyols of nominal functionality 2 to 3 that have molecular weights (number averaged) of from 100 g/mol to 8000 g/mol. Suitable polyether or polyester diols which can be utilized in the reactive component include those which are prepared by reacting alkylene oxides, halogen-substituted or aromatic-substituted alkylene oxides or mixtures thereof with an active hydrogen-containing initiator compound. Suitable oxides include, for example, ethylene oxide, propylene oxide, 1,2-butylene oxide, styrene oxide, epichlorohydrin, epibromohydrin, and mixtures thereof.

In one implementation, the reactive component includes relatively low molecular weight species containing two active hydrogen atoms, ethylene glycol, propylene glycol, 1,4-butandiol, butenediol, butynediol, hexanediol, bisphenols, diethylene glycol, dipropylene glycol, tripropylene glycol, triethylene glycol, mixtures of these, and like difunctional active hydrogen species.

In another implementation, aromatic diols, such as hydroquinone di(beta-hydroxyethyl) ether, or hydrazines, such as hydroxyethylhydrazine (HEH), are utilized in the prepolymer synthesis. Derivatives of hydrazine such as hydrazides (e.g., adipic dihydrazide (ADH)), hydrazones, or triazoles may also be utilized.

Additionally, the reactive component may include aliphatic amines and amine-substituted aromatics. By way of example, suitable compounds include diethylthtoluenediamine, diaminodiphenylmethane, polyoxypropylenediamine, secondary aliphatic diamines, cycloaliphatic diamines, and mixtures and reaction products thereof. Suitable secondary aliphatic diamines include polyaspartic ester compounds such as the Desmophen® polyaspartic esters from Bayer AG (Leverkusen, Germany). Sulfur diamines such as di-(methylthio)toluenediamine are suitable as well. Diethyltoluenediamine, diaminodiphenylmethane, and di-(methylthio)toluenediamine are preferred intermediate resin components. Moreover, in one embodiment, a caprolactone, such as a tri-functional polycaprolactone, is utilized as the reactive component in preparing the polyurethane-polyurea prepolymer formulations. More preferably, a blend of tri-functional compounds are utilized as the reactive component.

It should be further appreciated that the reactive component may include additives such as non-primary components, fillers, anti-aging agents, or coloring agents, for example. Moreover, in particular formulations, a catalyst such as an amine catalyst or organometallic catalyst may be utilized. The selection of catalysts can influence the shelf life of the final product. In implementations where a long shelf life is desirable, an organometallic catalyst or heat (approximately 140° F.) is preferable to an amine catalyst. Once the reactive component is selected, the polyisocyanate and the reactive component are mixed together to create the polyisocyanate prepolymer component.

The isocyanate-reactive component includes chain extenders and initiators that react with the NCO groups in the polyisocyanate prepolymer component to synthesize the polyurethane-polyurea polymer. In one embodiment, the isocyanate-reactive component may include organic compounds such as polyols, glycols, amine-substituted aromatics, and aliphatic amines, for example. In particular, the isocyanate-reactive component may include organic compounds similar to those described in connection with the reactive component hereinabove. By way of example, the isocyanate reactive component may include diethyltoluenediamine and an aromatic diamine. By way of another example, the isocyanate reactive component may include diethyltoluenediamine, a primary polyether triamine, and polyoxypropylenediamine.

In one embodiment, mercaptan functional moieties may also be incorporated into the isocyanate-reactive component as discussed in detail in the following commonly owned, co-pending patent application: “Isocyanate-reactive Component for Preparing a Polyurethane-polyurea Polymer,” filed on Nov. 3, 2004, application Ser. No. ______ (Attorney Docket No. 1006.1002), in the name of Michael S. Cork; which is hereby incorporated by reference for all purposes. It should be appreciated that additives such as non-primary components, fillers, anti-aging agents, or coloring agents, as well as catalysts, may also be utilized in the preparation of the isocyanate-reactive component. Once the isocyanate-reactive component is selected, the polyisocyanate prepolymer component and the isocyanate-reactive component are reacted together to create the polyurethane-polyurea polymer component.

The present invention will now be illustrated by reference to the following non-limiting working examples wherein procedures and materials are solely representative of those which can be employed, and are not exhaustive of those available and operative. Examples I-IX and the accompanying Test Methods illustrate the advantages of integrating mercaptan functional groups into a polyurethane-polyurea polymer. In particular, Examples VIII and IX and the accompanying Test Methods illustrate examples of incorporating the mercaptan functional groups into the polyurethane-polyurea polymer via the polyisocyanate prepolymer component synthesis route discussed in detail hereinabove. The following glossary enumerates the components utilized in the Examples and Test Methods presented hereinbelow.

CAPA® 3091 polyol is a 900 g/mol molecular weight caprolactone polyol from Solvay S.A. (Brussels, Belgium).

Castor oil is derived from the seeds of the castor bean, Ricinus communis, and is readily available.

DESMODUR® Z 4470 BA IPDI is an IPDI trimer from Bayer Corporation (Pittsburgh, Pa.).

ETHACURE® 100 curing agent is diethyltoluenediamine (DETA) from Albemarle Corporation (Baton Rouge, La.).

ETHACURE® 300 curing agent is di-(methylthio)toluenediamine (DMTDA) from Albermarle Corporation (Baton Rouge, La.).

GLYMO™ silane is 3-glycidoxypropyl trimethoxysilane from Degussa AG (Frankfort, Germany).

JEFFAMINE® D-2000 polyoxypropylenediamine is a difunctional primary amine having an average molecular weight of 2000 g/mol from Huntsman LLC (Salt Lake City, Utah).

JEFFAMINE® T-5000 polyol is a primary polyether triamine of approximately 5000 g/mol molecular weight from Huntsman LLC (Salt Lake City, Utah).

JEFFCAT® ZF-10 amine catalyst is N,N,N′-trimethyl-N′-hydroxyethyl-bisaminoethylether from Huntsman LLC (Salt Lake City, Utah).

JEFFLINK® 754 diamine is a bis(secondary amine) cycloaliphatic diamine from Huntsman LLC (Salt Lake City, Utah)

JEFFOX® PPG-230 glycol is a 230 g/mol molecular weight polyoxyalkylene glycol from Huntsman LLC (Salt Lake City, Utah).

JEFFSOL® propylene carbonate is a propylene carbonate from Huntsman LLC (Salt Lake City, Utah).

JP-7 Fuel Oil is jet propellant-7 fuel oil manufactured in accordance with the MIL-DTL-38219 specification from special blending stocks to produce a very clean hydrocarbon mixture that is low in aromatics and nearly void of sulfur, nitrogen, and oxygen impurities found in other fuels.

K-KAT® XC-6212 organometallic catalyst is a zirconium complex reactive diluent from King Industries, Inc. (Norwalk, Conn.).

METACURE® T-12 catalyst is a dibutyltin dilaurate catalyst from Air Products and Chemicals, Inc. (Allentown, Pa.).

MONDUR® ML MDI is an isomer mixture of MDI from Bayer Corporation (Pittsburgh, Pa.) that contains a high percentage of the 2′4 MDI isomer.

POLY-T® 309 polyol is a 900 g/mol molecular weight tri-functional polycaprolactone from Arch Chemicals, Inc. (Norwalk, Conn.).

PPG-2000™ polymer is a 2000 g/mol molecular weight polymer of propylene oxide from The Dow Chemical Company (Midland, Mich.).

RUBINATE® M MDI is a polymeric MDI from Huntsman LLC (Salt Lake City, Utah) which is prepared by the phosgenation of mixed aromatic amines obtained from the condensation of aniline with formaldehyde.

THIOPLAST™ G4 polysulfide is a less than 1000 g/mol molecular weight polysulfide from Akzo Nobel Inc. (Chicago, Ill.).

THIOPLAST™ G22 polysulfide is a 2400-3100 g/mol molecular weight polysulfide from Akzo Nobel Inc. (Chicago, Ill.).

TOLONATE® HDT-LV2 isocyanate is a tri-functional 1,6-hexamethylene diisocyanate-based polyisocyanate from Rhodia Inc. (Cranbury, N.J.).

TMXDI™ isocyanate is tetramethylenexylene diisocyanate from Cytec Industries, Inc. (West Paterson, N.J.)

UNILINK™ 4200 diamine is a 310 g/mol molecular weight 2-functional aromatic diamine from Dorf Ketal Chemicals, LLC (Stafford, Tex.) (formerly from UOP Molecular Sieves (Des Plaines, Ill.)).

Example I. An A-side prepolymer is made by reacting 2010 g of DESMODUR® Z 4470 BA IPDI with 900 g of POLY-T® 309 polyol and 160 g of TMXDI™ isocyanate. The ingredients are mixed vigorously for 5 minutes at a speed that is short of forming a vortex. Two grams of METACURE® T-12 catalyst are added and the ingredients are mixed for 3.5 hours under a blanket of inert nitrogen gas (N₂). A blanket of argon gas (Ar) or mild vacuum conditions are also suitable. It should be noted that 140° F. (60° C.) of heat may be substituted for the tin (Sn) catalyst. The A-side prepolymer formation is then complete. To the resulting A-side prepolymer, 250 g of JEFFSOL® propylene carbonate, which acts as a diluent, and 400 g of TOLONATE® HDT-LV2 isocyanate are added. The ingredients are mixed for 1 hour and the A-side formation is complete.

A B-side resin is formed by mixing 1295 g of JEFFLINK® 754 diamine with 740 g of THIOPLAST™ G22 polysulfide and 1665 g of THIOPLAST™ G4 polysulfide. The ingredients are stirred at ambient conditions until well mixed. A tertiary type amine catalyst may be utilized to increase the rate of the reaction. The B-side resin formation is then complete. The A-Side and the B-side are then loaded into a GX-7 spray gun, which is manufactured by Gusmer Corporation (Lakewood, N.J.), and impinged into each other at a 1:1 ratio at 2500 psi and 170° F. (77° C.). The resulting polymer gels in approximately 6 seconds and is tack free in approximately 11 seconds.

Example II. The polyurethane-polyurea polymer was prepared substantially according to the procedures presented in Example I with the components noted in Table VII.

TABLE VII
Polymer Formation (Example II)

| A-side | B-side |
|---|---|
| 66% by wt of MONDUR ® | 13% by wt of ETHACURE ® 100 |
| ML MDI | curing agent |
| 3% by wt of RUBINATE ® | 5% by wt of ETHACURE ® 300 |
| M MDI | curing agent |
| 25% by wt of POLY-T ® | 19% by wt of UNILINK ™ 4200 |
| 309 polyol | diamine |
| 4% by wt of GLYMO ™ | 33% by wt of THIOPLAST ™ G22 |
| silane | polysulfide |
| 2% by wt of additives | 30% by wt of THIOPLAST ™ G4 |
| (e.g., color control additives) | polysulfide |

Example III. The polyurethane-polyurea polymer was prepared substantially according to the procedures presented in Example I with the components noted in Table VIII.

TABLE VIII
Polymer Formation (Example III)

| A-side | B-side |
|---|---|
| 52.5% by wt of MONDUR ® | 10% by wt of ETHACURE ® 100 |
| ML MDI | curing agent |
| 2.25% by wt of RUBINATE ® | 26% by wt of UNILINK ™ 4200 |
| M MDI | diamine |
| 20.25% by wt of POLY-T ® | 34% by wt of THIOPLAST ™ G22 |
| 309 polyol (CAPA ® 3091 | polysulfide |
| polyol is a suitable alternative | |
| 45% by wt of TOLONATE ® | 30% by wt of THIOPLAST ™ G4 |
| HDT-LV2 isocyanate | polysulfide |

Example IV. The polyurethane-polyurea polymer was prepared substantially according to the procedures presented in Example I with the components noted in Table IX.

TABLE IX
Polymer Formation (Example IV)

| A-side | B-side |
|---|---|
| 70.5% by wt of MONDUR ® | 35% by wt of JEFFOX ® PPG-230 |
| ML MDI | glycol |
| 26% by wt of POLY-T ® | 25% by wt of THIOPLAST ™ G22 |
| 309 polyol | polysulfide |
| 3.5% JEFFSOL ® | 40% by wt of THIOPLAST ™ G4 |
| propylene carbonate | polysulfide |

Example V. The polyurethane-polyurea polymer was prepared substantially according to the procedures presented in Example I with the components noted in Table X.

TABLE X
Polymer Formation (Example V)

| A-side | B-side |
|---|---|
| 66.5% by wt of MONDUR ® | 25% by wt of ETHACURE ® 100 |
| ML MDI | curing agent |
| 16.75% by wt of PPG-2000 ™ | 65% by wt of THIOPLAST ™ G4 |
| polymer | polysulfide |
| 16.75% by wt of Castor oil | 10% by wt of JEFFAMINE ® T-5000 |
| | polyol |

Example VI. The polyurethane-polyurea polymer was prepared substantially according to the procedures presented in Example I with the components noted in Table XI.

TABLE XI
Polymer Formation (Example VI)

| A-side | B-side |
|---|---|
| 77% by wt of MONDUR ® | 13.5% by wt of ETHACURE ® 100 |
| ML MDI | curing agent |
| 23% by wt of Castor oil | 70.5% by wt of THIOPLAST ™ G4 |
| | polysulfide |
| | 16% by wt of UNILINK ™ 4200 |
| | diamine |

Example VII. The polyurethane-polyurea polymer was prepared substantially according to the procedures presented in Example I with the components noted in Table XII.

TABLE XII
Polymer Formation (Example VII)

| A-side | B-side |
|---|---|
| 70% by wt of MONDUR ® | 13.5% by wt of ETHACURE ® 100 |
| ML MDI | curing agent |
| 4% by wt of RUBINATE ® | 70.5% by wt of THIOPLAST ™ G4 |
| M MDI | polysulfide |
| 26% by wt of POLY-T ® | 16% by wt of UNILINK ™ 4200 |
| 309 polyol | diamine |

Example VIII. The polyurethane-polyurea polymer was prepared substantially according to the procedures presented in Example I with the components noted in Table XIII.

TABLE XIII
Polymer Formation (Example VIII)

| A-side | B-side |
|---|---|
| 70% by wt of MONDUR ® | 25% by wt of ETHACURE ® 100 |
| ML MDI | curing agent |
| 4% by wt of RUBINATE ® | 4% by wt of JEFFAMINE ® T-5000 |
| M MDI | polyol |
| 25% by wt of THIOPLAST ™ | 71% by wt of JEFFAMINE ® D-2000 |
| G4 polysulfide | polyoxypropylenediamine |
| <1% by wt of JEFFCAT ® | |
| ZF-10 amine catalyst | |
| <1% by wt of K-KAT ® | |
| XC-6212 organometallic catalyst | |

Example IX. The polyurethane-polyurea polymer was prepared substantially according to the procedures presented in Example I with the components noted in Table XIV.

TABLE XIV
Polymer Formation (Example IX)

| A-side | B-side |
|---|---|
| 70% by wt of MONDUR ® | 13% by wt of ETHACURE ® 100 |
| ML MDI | curing agent |
| 4% by wt of RUBINATE ® | 19% by wt of UNILINK ™ 4200 |
| M MDI | diamine |
| 25% by wt of THIOPLAST ™ | 30% by wt of THIOPLAST ™ G22 |
| G4 polysulfide | polysulfide |
| <1% by wt of JEFFCAT ® | 38% by wt of THIOPLAST ™ G4 |
| ZF-10 amine catalyst | polysulfide |
| <1% by wt of K-KAT ® | |
| XC-6212 organometallic catalyst | |

The following tables, Tables XV-XVII, provide a survey of the mercaptan content of the polymers synthesized in accordance with Examples I-IX.

TABLE XV
Mercaptan Content

| Polymer Example | I | II | III |
|---|---|---|---|
| Mercaptan Content (%) | 1.3-2.2 | 1.2-1.9 | 1.2-2.0 |

TABLE XVI
Mercaptan Content

| Polymer Example | IV | V | VI |
|---|---|---|---|
| Mercaptan Content (%) | 1.4-2.3 | 1.9-3.3 | 2.1-3.5 |

TABLE XVII
Mercaptan Content

| Polymer Example | VII | VIII | IX |
|---|---|---|---|
| Mercaptan Content (%) | 2.1-3.5 | 0.7-1.3 | 2.2-3.6 |

The foregoing Examples I-IX of the present invention were tested against a high-tensile strength standard polyurea (HTS-SP) of conventional preparation having components noted in Table XVIII.

TABLE XVIII
Formation of HTS-SP

| A-side | B-side |
|---|---|
| 60% by wt of MONDUR ® | 25% by wt of ETHACURE ® 100 |
| ML MDI | curing agent |
| 40% by wt of PPG-2000 ™ | 10% by wt of JEFFAMINE ® T-5000 |
| polymer | polyol |
| | 70% by wt of JEFFAMINE ® D-2000 |
| | polyoxypropylenediamine |

Test Method I. A polyurethane-polyurea polymer of the present invention synthesized in accordance with Example V (Ex. V Polymer) and the HTS-SP were tested according to the standard test method for tensile properties of plastics prescribed in American Society for Testing and Materials (ASTM) D638. This test method covers the determination of the tensile properties of unreinforced and reinforced plastics in the form of standard dumbbell-shaped test specimens when tested under defined conditions of pretreatment, temperature, humidity, and testing machine speed. Table XIX depicts the ASTM D638 test results for the Ex. V Polymer and the HTS-SP.

TABLE XIX
ASTM D638 Test Results

| | Mean Yield | Mean Maximum | Mean Young's |
|---|---|---|---|
| Polymer | Stress (psi) | Strain (%) | Modulus (psi) |
| Ex. V Polymer | 2,419 | 110 | 28,414 |
| HTS-SP | 1,024 | 561 | 10,768 |

Test Method II. The Ex. V Polymer and the HTS-SP were tested according to the standard test method for water transmission of materials prescribed in ASTM E96. This test method covers the determination of water vapor transmission of materials through which the passage of water vapor may be of importance. Table XX depicts the ASTM E96 test results for the Ex. V Polymer and the HTS-SP.

TABLE XX
ASTM E96 Test Results

| | Mean Permeance | Mean Average Permeability |
|---|---|---|
| Polymer | (perms) | (perms-in) |
| Ex. V Polymer | 0.204 | 0.007 |
| HTS-SP | 1.632 | 0.066 |

Test Method III. The Ex. V Polymer and the HTS-SP were tested according to the standard test method for tear strength of conventional vulcanized rubber and thermoplastic elastomers prescribed in ASTM D624. This test method describes procedures for measuring a property of conventional vulcanized thermoset rubber and thermoplastic elastomers called tear strength. Table XXI depicts the ASTM D624 test results for the Ex. V Polymer and the HTS-SP.

TABLE XXI
ASTM D624 Test Results

| Polymer | Maximum Load (lbs) | Tear PLI (lbs/lin in) |
|---|---|---|
| Ex. V Polymer | 15.47 | 449.6 |
| HTS-SP | 16.13 | 476.2 |

Testing Method IV. A polyurethane-polyurea polymer of the present invention synthesized in accordance with Example III (Ex. III Polymer), the HTS-SP, and a conventional polyurea were tested to evaluate resistance to chemical reagents and, in particular, resistance to gasoline, xylene, and diesel fuel. Each of polymers under evaluation was sealed in a glass receptacle containing one of the three test fluids for 30 days at ambient conditions. At the end of the 30 days, change in weight was recorded. Table XXII depicts the Chemical Resistance test results, i.e., percent weight increase, for the Ex. III Polymer, the HTS-SP, and the conventional polyurea (CP).

TABLE XXII
Chemical Resistance Test Results

| | Gasoline | Xylene | Diesel Fuel |
|---|---|---|---|
| Polymer | (% wt inc.) | (% wt inc.) | (% wt inc.) |
| Ex. III Polymer | 1.4 | 8.7 | 0.7 |
| HTS-SP | 26.3 | 37.1 | 10.9 |
| CP | 69.1 | 110.3 | 21.4 |

After 30 days, the test fluid in each of the three receptacles housing the Ex. III Polymer was exchanged out and the testing continued. After a total of 120 days, weight increases of the Ex. III Polymer were 4.8%, 11.6%, and 1.4% for gasoline, xylene, and diesel fuel, respectively. Additionally, the Ex. I-II and IV-IX Polymers exhibited chemical resistance with respect to gasoline, xylene, and diesel fuel substantially equivalent to the Ex. III Polymer.

Testing Method V. A polyurethane-polyurea polymer of the present invention synthesized in accordance with Example IX (Ex. IX Polymer) was tested to evaluate resistance to chemical reagents and, in particular, resistance to a mixture of JP-7 Jet Fuel Oil and toluene. The Ex. IX Polymer under evaluation was sealed in a glass receptacle containing 30% JP-7 Jet Fuel Oil and 70% toluene. Periodically changes in weight and dimension were recorded. Table XXIII depicts the Chemical Resistance test results, i.e., percent weight increase and percent dimension increase, for the Ex. IX Polymer.

TABLE XXIII
Chemical Resistance Test Results

| | Weight Increase | Dimension Increase |
|---|---|---|
| TIME | (% wt inc.) | (% dim inc.) |
| 24 hours | 1.6% | <0.5% |
| 72 hours | 2.7% | <0.5% |
| 96 hours | 3.2% | <0.5% |
| 120 hours | 3.4% | <0.5% |

Moreover, the Ex. I-VIII Polymers exhibited jet fuel oil/toluene resistance substantially equivalent to the Ex. IX Polymer. Accordingly, the results of Testing Methods I-V illustrate that the polyurethane-polyurea polymers having the mercaptan functional moieties in accordance with the teachings presented herein exhibit physical properties that are equivalent or better than those of existing polyurethane-polyurea polymers. Further, the polyurethane-polyurea polymers synthesized according to the teachings presented herein exhibit chemical resistance at least an order of magnitude better than existing polyurethane-polyurea polymers.

What is claimed is:

1. A process for preparing a polymer, comprising reacting:
a polyisocyanate prepolymer component having an NCO group content of about 3% to about 50% and an average functionality of about 2 to about 3, the polyisocyanate prepolymer component comprising the reaction product of a polyisocyanate with a reactive component,
wherein the reactive component includes from about 20% to about 100% by weight, based on 100% by weight of the reactive component, of at least one organic compound having a mercaptan functional moiety; and
an isocyanate-reactive component.

2. The process as recited in claim 1, wherein the polyisocyanate prepolymer component and the isocyanate-reactive component are reacted using a high-pressure impingement mixing technique.

3. The process as recited in claim 1, wherein the polyisocyanate prepolymer component and the isocyanate-reactive component are reacted at a temperature in a range of about 145° F. to about 190° F.

4. The process as recited in claim 1, wherein the polyisocyanate prepolymer component and the isocyanate-reactive component are reacted in approximately a 1:1 ratio.

5. The process as recited in claim 1, wherein the polyisocyanate comprises diphenylmethane diisocyanate.

6. The process as recited in claim 1, wherein the polyisocyanate comprises a blend of isocyanates selected from the group consisting of aliphatic polyisocyantes, cycloaliphatic polyisocyanates, and aromatic polyisocyanates.

7. The process as recited in claim 1, wherein the reactive component comprises a polysulfide.

8. The process as recited in claim 1, wherein the reactive component comprises a reaction product of diethyltoluenediamine, di-(methylthio)toluenediamine, an aromatic diamine, and a polysulfide.

9. The process as recited in claim 1, wherein the reactive component comprises a reaction product of diethyltoluenediamine, an aromatic diamine, and a polysulfide.

10. The process as recited in claim 1, wherein the reactive component comprises a reaction product of diethyltoluenediamine, a polyol, and a polysulfide.

11. The process as recited in claim 1, wherein the reactive component comprises a reaction product of a cycloaliphatic diamine and a polysulfide.

12. The process as recited in claim 1, wherein the reactive component comprises a reaction product of a polyaspartic ester and a polysulfide.

13. The process as recited in claim 1, wherein the reactive component comprises a reaction product of a glycol and a polysulfide.

14. The process as recited in claim 1, wherein the reactive component comprises a reaction product of diethyltoluenediamine, polyoxypropylenediamine, and a polysulfide.

15. The process as recited in claim 1, wherein the isocyanate-reactive component comprises an organic compound selected from the group consisting of amine-substituted aromatics, aliphatic amines, and glycols.

16. The product produced by the process of claim 1.

17. The process as recited in claim 1, wherein the isocyanate-reactive component comprises a polysulfide.

18. The product produced by the process of claim 17.

19. A process for preparing a polyisocyanate prepolymer component, comprising reacting:
a polyisocyanate having an average functionality of about 2 to about 3 in an amount from about 50% to about 98% by weight; and
a reactive component in an amount from about 2% to about 50% by weight, the reactive component including from about 20% to about 100% by weight, based on 100% by weight of the reactive component, of at least one organic compound having a mercaptan functional moiety,
wherein the resulting polyisocyanate prepolymer component has an NCO group content of about 3% to about 50%.

20. The process as recited in claim 19, wherein the polyisocyanate and the reactive component are reacted under agitation.

21. The process as recited in claim 19, wherein the polyisocyanate comprises diphenylmethane diisocyanate.

22. The process as recited in claim 19, wherein the polyisocyanate comprises a blend of isocyanates selected from the group consisting of aliphatic polyisocyantes, cycloaliphatic polyisocyanates, and aromatic polyisocyanates.

23. The process as recited in claim 19, wherein the reactive component comprises an organic compound selected from the group consisting of amine-substituted aromatics, aliphatic amines, and glycols.

24. The process as recited in claim 19, wherein the reactive component comprises a polysulfide.

25. The process as recited in claim 24, wherein the polysulfide comprises a polycondensation product of bis-(2-chloroehtyl-)formal and an alkali polysulfide.

26. The process as recited in claim 24, wherein the polysulfide comprises a polycondensation product of bis-(2-chloroehtyl-)formal, an alkali polysulfide, and 1,2,3-trichloropropane.

27. The process as recited in claim 19, wherein the reactive component comprises a polymercaptan.

28. The process as recited in claim 19, further comprising reacting an amine catalyst.

29. The process as recited in claim 19, further comprising reacting an organometalilc catalyst.

30. The product produced by the process of claim 19.
